(19) United States
(12) Patent Application Publication
(10) Pub. No.: US 2003/0180624 A1
(43) Pub. Date: Sep. 25, 2003

(54) Solid polymer electrolyte and method of preparation

(76) Inventors: Bookeun Oh, Lisle, IL (US); Khalil Amine, Downers Grove, IL (US); Yoo-Eup Hyung, Lisle, IL (US); Donald R. Vissers, Naperville, IL (US)

Correspondence Address: MARY ELIZABETH BUSH, QUALLION LLC, P.O. BOX 923127, SYLMAR, CA, 91392-3127, US

(21) Appl. No.: 10/104,352

(22) Filed: Mar. 22, 2002

(51) Int. Cl. H01M 10/40; H01M 10/04

(52) U.S. Cl. 429/313; 429/317; 429/309; 29/623.5

(57) ABSTRACT

Disclosed is an improved solid electrolyte made of an interpenetrating network type solid polymer comprised of two compatible phases: a crosslinked polymer for mechanical strength and chemical stability, and an ionic conducting phase. The highly branched siloxane polymer of the present invention has one or more poly(ethylene oxide) (“PEO”) groups as a side chain. The PEO group is directly grafted to silicon atoms in the siloxane polymer. This kind of branched type siloxane polymer is stably anchored in the network structure and provides continuous conducting paths in all directions throughout the IPN solid polymer electrolyte. Also disclosed is a method of making an electrochemical cell incorporating the electrolyte. A cell made accordingly has an extremely high cycle life and electrochemical stability.

### CONTRACTUAL ORIGIN OF THE INVENTION

The United States Government has rights in this invention pursuant to NIST ATP Award No. 70NANB043022 and Contract No. W-31-109-ENG-38 between the United States Department of Energy and the University of Chicago for the operation of Argonne National Laboratory.

### REFERENCE TO PRIOR FILED APPLICATIONS

None

### FIELD OF THE INVENTION

The present invention relates to the composition and assembly methods of solid polymer electrolytes and their use in electrochemical cells, especially in lithium ion rechargeable batteries. The invention particularly relates to interpenetrating network type solid polymer electrolyte systems with highly ionic conductivity poly(ethylene oxide) (“PEO”) grafted siloxane polymers as a conducting phase.

### BACKGROUND OF THE INVENTION

Efforts to develop electrochemical cells having PEO based solid electrolyte systems have continued since about 1973. (M. B. Armand, Fast Ion Transport in Solids, North Holland, Amsterdam, p665, (1973); D. E. Fenton et al., Polymer, 14, 589 (1973)). The main advantages of such a cell system are multifold: (1) very high energy density; (2) potential for excellent electrolyte stability; (3) the ability to be configured in nearly any shape since it contains no liquid; (4) the opportunity to be very inexpensive; (5) inherent safety characteristics; and (6) an expansive market if successfully developed. Up to now the key impediment to the successful development of such a polymer cell for room temperature operation is the low ionic conductivity of the solid polymer electrolyte. A major effort to develop the solid polymer electrolyte (“SPE”) system is being carried out by Hydro Quebec and 3M under contract to the United States Advanced Battery Consortium (USABC) for electric vehicle applications. The batteries developed in this effort are operated at approximately 60° C. to 80° C. (140° F. to 176° F.), and achieve about 800 cycles (M. Gauthier et al., J. Power Sources, 54, 163 (1995)). All attempts in this program to successfully develop a room temperature SPE based battery were unsuccessful because of the low ionic conductivity at room temperature of PEO based electrolyte using the lithium trifluoromethane sulfonyl imide [LiN(CF₃SO₃), LiTFSI] salt (“TFSI”). Based on examination and evaluation of the various solid electrolytes developed to date (L.A. Dominey et al., Electrochim. Acta, 37, 1551 (1992); F. Alloin et al., Solid State Ionics, 60, 3 (1993)), it is quite apparent that PEO based polymer or derivative thereof appear to be the most promising.

One type of PEO investigated thoroughly is the high molecular weight (about 4 million) linear variety, which forms relatively strong, free-standing films at room temperature. Its strength is derived from a semicrystalline microstructure. Lithium ion transport in such materials depends on the complexation of lithium ions by the oxygen atoms in oxyethylene units in the polymer chains. High molecular weight PEO doped with the lithium salt LiN(SO₂CF₃)₂, LiTFSI, has an optimum conductivity of 10⁻⁵ S/cm at 80° C. (176° F.) (S. Kohama et al., J. Appl. Polym. Sci., 21, 863 (1977)). Many lithium salt complexes of PEO at room temperature are predominantly crystalline until a melting point of 68° C. (154.5° F.) leading to very poor ionic conductivities of approximately 10⁻⁷ S/cm. The improved conductivities using the TFSI salt are due to the plasticizing effect of the anion which substantially reduces the crystallinity of the PEO complex at room temperature. It is important to note that only the amorphous PEO electrolyte is ionically conductive.

Substantial research effort has been devoted to lowering the operating temperature of SPE to the ambient region. To solve this problem, alkyl phthalates and poly(ethylene glycol) dialkyl ether with low molecular weight have been used as plasticizing additives for SPE to reduce the crystalline region and increase the mobility of the SPE molecular chain at ambient temperature. Low molecular poly(ethylene oxide-dialkyl ether compounds) can contribute to increased room temperature ionic conductivity of SPE, but they still have crystallization problem which decrease the ionic conductivity at certain temperature. Another approach to attempt to improve the ionic conductivity at ambient temperature was to synthesize a highly branched PEO to decrease the crystalline tendency of PEO main chain and to increase the chain mobility regarding lithium ion transport such as hyper-branched SPE (Z. Wang et al., J. Electrochem. Soc., 146(6), 2209 (1999)), and comb-like SPEs (J. S. Gnanaraj, R.N. Karekar et al., Polymer, 38(14) 3709 (1997)). However, the ionic conductivity of such highly branched PEO is still low at ambient temperature. All of these efforts were intended to create amorphous polymer near ambient temperature.

To apply a SPE to a real practical electrochemical cell system, adequate mechanical strength is required. Simple crystalline PEO may meet that requirement, but most of modified PEO based SPEs are not strong enough for real cell applications. Crosslinked SPEs were developed as a solution, but the crosslinking reaction restricts polymer chain mobility that is needed for lithium ion transport. (U.S. Pat. No. 4,908,283 to Takahashi, U.S. Pat. No. 4,830,939 to Lee, U.S. Pat. No. 5,037,712 to Shackle and U.S. Pat. No. 3,734,876 to Chu). More advanced systems are the interpenetrating network (“IPN”) type SPE that consist of crosslinked polymers and an ionic conducting phase which is mostly low molecular weight PEO base compounds. The ionic conductivity of such systems, however, still depends on the flexibility of poly(alkylene oxide) which has a temperature dependency on its mobility, as well as on its mechanical strength which is not obvious. Most prior patents have disclosed the use of volatile solvents to dissolve the PEO compounds and metal salts. The use of volatile solvents to make the SPEs increase the processing steps such as evaporation and recovery, increase costs of manufacture, and may pose serious environmental and safety issues. U.S. Pat. No. 5,112,512 to Nakamura discloses crosslinking PEO crosslinking agent to siloxane with a PEO side chain which has a reactive unsaturated bond. This crosslinking approach results in a significantly reduced flexibility of siloxane with PEO polymer. The present invention is distinguished in that the siloxane is captured inside the network with no chemical bonds to the PEO crosslinking agent, greatly enhancing flexibility.

Accordingly, the present inventors have developed a new type of IPN polymer electrolyte having PEO grafted onto polysiloxanes as an ion conducting phase and a porous support to overcome the above-mentioned problems such as low room temperature ionic conductivity, chemical and electrochemical stability, as well as safety. The PEO grafted polysiloxanes are liquid compounds, electrochemically stable and have low glass transition temperature with little or no crystallization problems. Notably the present invention does not include any volatile solvent in the polymer electrolyte preparation.

### OBJECTIVES OF THE INVENTION

A primary objective of the present invention is to provide an IPN SPE having increased room temperature ionic conductivity with chemical and electrochemical stability.

Another object of the invention is to provide a thin IPN SPE with reduced bulk impedance and excellent mechanical strength.

An additional object of the present invention is to provide an improved method to manufacture an electrochemical battery having an IPN solid polymer.

To fulfill the above objectives, the IPN SPE in the present invention is fabricated by using the composition which comprises branched type siloxane polymer in a liquid state, crosslinking agent selected from diacrylate terminated poly(alkylene oxide) compounds, crosslinking density controlling compounds selected from poly(alkylene oxide) acrylate alkyl ether compounds, a lithium salt and a thermal initiator.

A further object of the invention is to provide a fabrication method to prepare the IPN type SPEs through thermal crosslinking. This method uses a porous media such as polyolefin separator, nonwoven fabrics, polycarbonate membrane, etc. to reduce the bulk impedance of SPE through minimizing its thickness.

### SUMMARY OF THE INVENTION

The present invention relates to a SPE and its preparation method. More particularly, the present invention relates to an IPN type SPE having PEO grafted siloxane polymer as the major ionic conducting phase which has excellent ionic conductivity and mechanical strength, and its preparative method is quite simple. The SPEs resulting from the present invention are suitable electrolytes for lithium polymer secondary batteries.

### BRIEF DESCRIPTION OF THE DRAWINGS

FIG. 1 is a temperature vs. ionic conductivity graph for the present invention.

FIG. 2 is a flow chart illustrating the steps of a method for implementing the present invention.

FIG. 3 is a flow chart illustrating the steps of another method for implementing the present invention.

FIG. 4 is a flow chart illustrating the steps of another method for implementing the present invention.

FIG. 5 is a flow chart illustrating the steps of another method for implementing the present invention.

FIG. 6 is a graph showing the cyclic voltammogram of electrochemical stability.

FIGS. 7a, 7b and 7c are graphs showing the measured heat flow from decomposition reaction of test samples.

FIGS. 8a and 8b show a potentiostatic curve (FIG. 8a) and impedance spectra (FIG. 8b) of lithium metal/IPN SPE of Example 2/lithium metal cell to measure lithium transference number of the SPE.

FIGS. 9a and 9b show a charge/discharge pattern (FIG. 9a) and specific discharge capacity (FIG. 9b) according to cycle number of lithium metal/IPN SPE of Example 8/LiNi _{0.8}Co_{0.2}O₂ cathode cell.

FIG. 10a is an illustration of the method of fabricating a cell according to the present invention.

FIG. 10b is a cut-away drawing of an electrochemical cell incorporating a SPE.

### DETAILED DESCRIPTION OF THE INVENTION

The SPE of the present invention comprises an IPN of two separate continuous phases that are compatible with each other. One of the phases is a crosslinked polymer that ensures its mechanical strength and chemical stability, and the other is a conducting phase for dissociating ion. The crosslinking phase can also assist metal salt dissolution and transportation.

The elaborately designed highly branched siloxane polymer of the present invention has one or more PEO groups as a side chain. The PEO group is directly grafted to silicon atoms in the siloxane polymer. This kind of branched type siloxane polymer is stably anchored in the network structure and provides continuous conducting paths in all directions throughout the IPN SPE.

The branched type siloxane polymer easily dissolves the lithium salt and has the required flexibility to transport the lithium ions. Through the fabrication method suggested by this invention, the polysiloxane is well anchored in the IPN polymer electrolyte and increases the polymer ionic conductivity by its high segmental mobility.

The present invention includes all types of siloxane polymers with PEO as a side chain and the branched type siloxane polymers represented by the formula (I-a and I-b) are specific examples of the present invention:

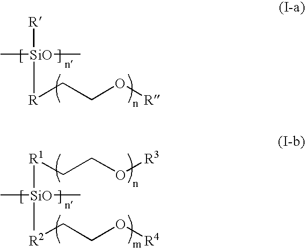

Wherein each of R, R¹ and R² represents oxygen or a group selected from an alkylene oxide group having 1 to 6 carbon atoms; each of R′, R″, R³ and R⁴ represents hydrogen or a group selected from an alkyl group having 1 to 12 carbon atoms and/or an alkenyl group having 2 to 8 carbon atoms; each of n and m represents whole numbers from 1 to 12; and n′ represents whole numbers from 10-10,000.

The crosslinking agent in the present invention is represented by formula (II):

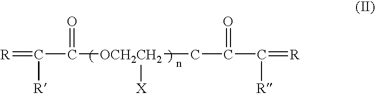

Wherein R represents a group selected from an alkyl group having 1 to 10 carbon atoms; and each of R′ and R″ represents hydrogen or a group selected from an alkyl group having 1 to 10 carbon atoms and/or an alkenyl group having 2 to 12 carbon atoms; and X being hydrogen or a methyl group; and n represents a numeral of 1 to 15.

The monomer used for the control of crosslinking density of the IPN SPE is represented by formula (III):

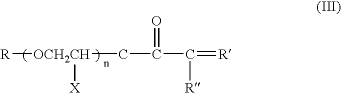

Wherein each of R and R′ represents a group selected from an alkyl group having 1 to 10 carbon atoms; and R″ represents hydrogen or a group selected from an alkyl group having 1 to 10 carbon atoms and/or an alkenyl group having 2 to 12 carbon atoms; and X is hydrogen or a methyl group; and n represents a numeral of 1 to 20.

The lithium salt to be used in the present invention is not particularly limited, as long as it dissolves in the polymer and serves as an electrolyte for a lithium secondary battery. Examples of specific lithium salts include LiClO₄, LiBF₄, LiAsF₆, LiPF₆, LiCF₃SO₃, Li(CF₃SO₂)₂N, Li(CF₃SO₂)₃C, LiN(SO₂C₂F₅) ₂), lithium alkyl fluorophosphates and a mixture thereof, as well as salts yet to be identified.

The molar ratio of the lithium salt to the oxygen in the organic mixture of branched type siloxane polymer, crosslinking agent and monofunctional compound is preferably 0.01 to 0.2. If the proportion of the lithium salt is smaller than 0.01, the ionic conductivity of the resulting IPN SPE is significantly decreased because of an inadequate number of carrier ions are in the SPE. If the molar ratio is greater than 0.2, the lithium salt is not sufficiently dissociated in the resulting IPN SPE and the aggregation of lithium ion can reduce the ionic conductivity.

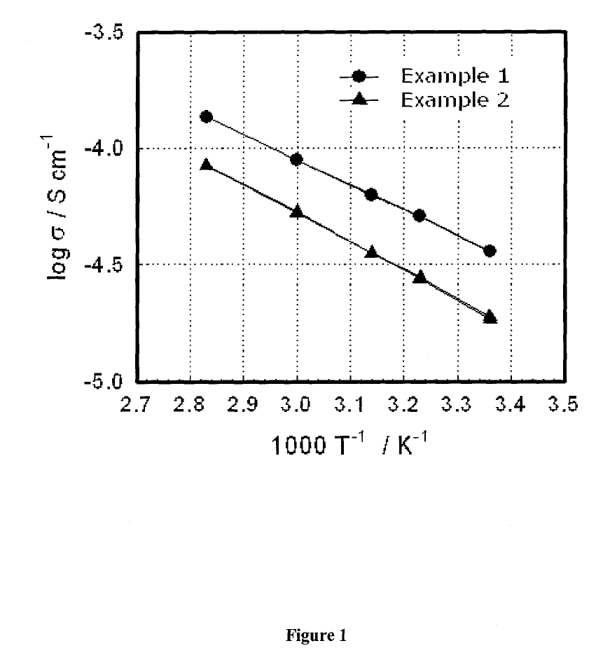

FIG. 1 shows the effect of temperature on the ionic conductivity of two IPN polymer electrolytes. Example 1 is with 60 wt % branched type siloxane polymer (n=7.2 in formula I-a), 30 wt % poly(ethylene glycol) ethyl ether methacrylate, 10 wt % of poly(ethylene glycol-600) dimethacrylate and Li(CF₃SO₂)₂N. Example 2 is with 50 wt % branched type siloxane polymer (n=7.2, R′ and R″ are methyl groups in formula I-a), 40 wt % poly(ethylene glycol) ethyl ether methacrylate, 10 wt % of poly(ethylene glycol-600) dimethacrylate and Li(CF₃SO₂)₂N. Both of the two IPN SPEs show high ionic conductivity over 10⁻⁵S/cm at room temperature. The anchored siloxane, without any chemical bonding with the IPN structure, gives improved ionic conductivity to the IPN type crosslinked SPE. More important is the content of liquid siloxane in the IPN SPE; as the more content of branched type siloxane polymer is increased, so is the ionic conductivity.

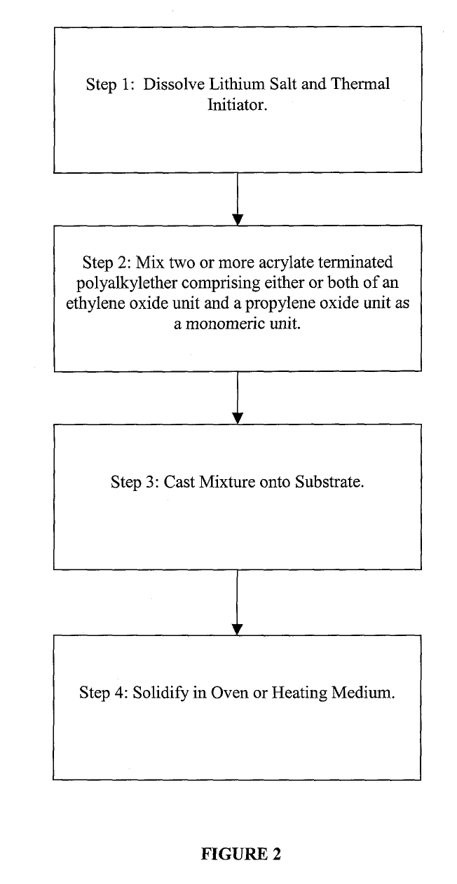

FIG. 2 delineates the requisite steps in a method for preparing an interpenetrating network type polymer electrolyte, comprising the steps of: (1) dissolving a lithium salt and a thermal initiator selected from azo compounds such as azoisobutyronitrile, peroxide compounds such as benzoylperoxide and bismaleimide in a branched type siloxane based polymer (formula I-a or I-b); (2) mixing two or more acrylate terminated polyalkylether comprising either or both of an ethylene oxide unit and a propylene oxide unit as a monomeric unit in the resulting solution; (3) casting the resulting mixture called a precursor solution onto a substrate, porous medium such as polyolefin separator, nonwoven and polycarbonate membrane or a surface of the electrode; and (4) placing the cast film in an oven or on a heating medium for solidification thereof.

The porous media of the present invention will be used to reduce the thickness of IPN SPE and are preferably polyolefin separator, nonwovens and polycarbonate microporous membrane. The final thickness of SPE of the present invention with the porous supporter is below 100 μm, preferably below 50 μm.

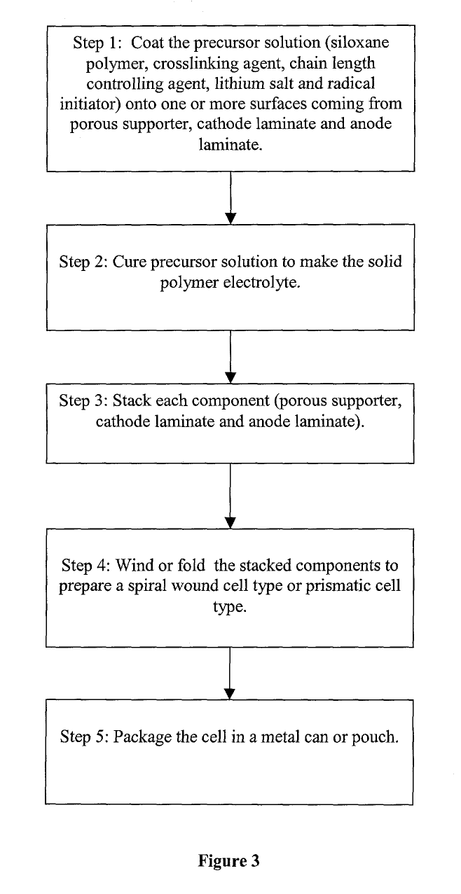

FIG. 3 delineates the method for assembling a lithium rechargeable cell with the SPE of the present invention, comprises the steps of: (1) coating the precursor solution including siloxane polymer, crosslinking agent, chain length controlling agent, lithium salt and radical initiator onto one or more surfaces coming from porous supporter, cathode laminate and anode laminate; (2) curing the precursor solution to make the SPE; (3) stacking each components including porous supporter, cathode laminate and anode laminate properly; (4) winding or folding the stacked components to prepare the spiral wound cell type or prismatic cell type; and (5) packaging the cell in a metal can, plastic pouch or laminated plastic/metal foil pouch. Such stacking, winding and packaging are well known in the art.

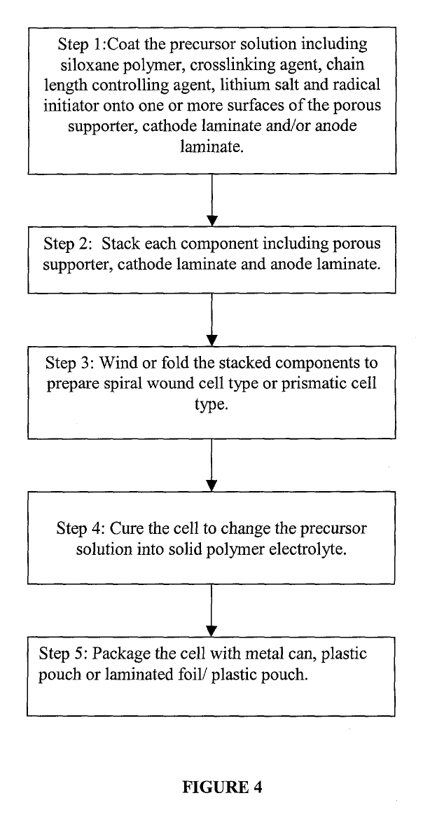

FIG. 4 denotes another method for assembling lithium rechargeable cell with the SPE of the present invention, comprises the steps of: (1) coating the precursor solution including siloxane polymer, crosslinking agent, chain length controlling agent, lithium salt and radical initiator onto one or more surfaces coming from porous supporter, cathode laminate and anode laminate; (2) stacking each component, including porous supporter, cathode laminate and anode laminate properly; (3) winding or folding the stacked components to prepare spiral wound cell type or prismatic cell type; (4) curing the cell to change the precursor solution into SPE; and (5) packaging the cell with metal can, plastic pouch or laminated foil/ plastic pouch.

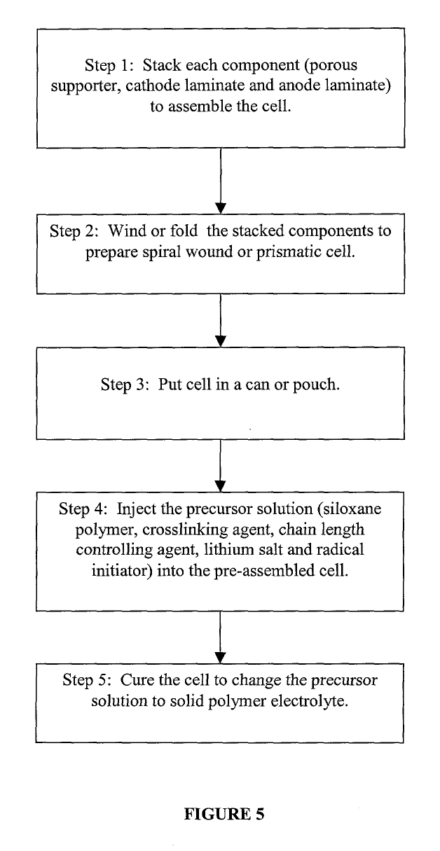

FIG. 5 denotes the steps of another method for assembling the lithium rechargeable cell with the SPE of the present invention, comprises the steps of: (1) stacking each component including porous supporter, cathode laminate and anode laminate properly to assemble the cell; (2) winding or folding the stacked components to prepare spiral wound cell type or prismatic cell type; (3) putting the cell in a metal can, plastic pouch or laminated metal foil/plastic pouch; (4) injecting the precursor solution including siloxane polymer, crosslinking agent, chain length controlling agent, lithium salt and radical initiator into the pre-assembled cell; and (5) curing the cell to change the precursor solution to SPE.

The present invention will be better understood by reference to the following examples which are intended for purposes of illustration and are not intended to nor are to be interpreted in any way as limiting the scope of the present invention, which is defined in the claims appended hereto.

### EXAMPLES 1-2

For Examples 1-2, Li(CF₃SO₂)₂N (LiTFSI) salt was dissolved in a branched type siloxane polymer (n=7.2, R′ and R″ are methyl groups in formula I-a, Mₙ=ca. 2000), poly(ethylene glycol) ethyl ether methacrylate (PEGEEMA) with average Mₙ of ca. 246 and poly(ethylene glycol-600) dimethacrylate (PEGDMA600) with average Mₙ of ca. 740 mixture. After clear dissolution of LiTFSI, benzoyl peroxide was added into the resulting solution and mixed to get a precursor solution for IPN type SPE. The composition of Examples 1-2 is shown in Table 1. Porous polycarbonate membrane is used as a supporter for the IPN SPEs. The ionic conductivity of the IPN polymer electrolytes at temperatures ranging from 25 to 80° C. were measured from the ac impedance curves of 2030 button cells assembled by sandwiching the IPN SPE between two stainless steel discs with a frequency range from 1 MHz to 10 Hz. The result is shown in FIG. 1. Both of two IPN SPEs show high ionic conductivity over 10⁻⁵ S/cm at room temperature and as the content of branched type siloxane polymer is increased, so is the ionic conductivity.

TABLE 1
[grams]

| | Composition | | | | |
|---|---|---|---|---|---|
| | Branched | | | | |
| | siloxane | | | | |
| Example # | polymer | PEGDMA600 | PEGEEMA | LiTFSI | BPO |
| 1 | 0.400 | 0.400 | 1.200 | 0.770 | 0.016 |
| 2 | 2.000 | 0.400 | 1.600 | 0.800 | 0.020 |

### EXAMPLE 3

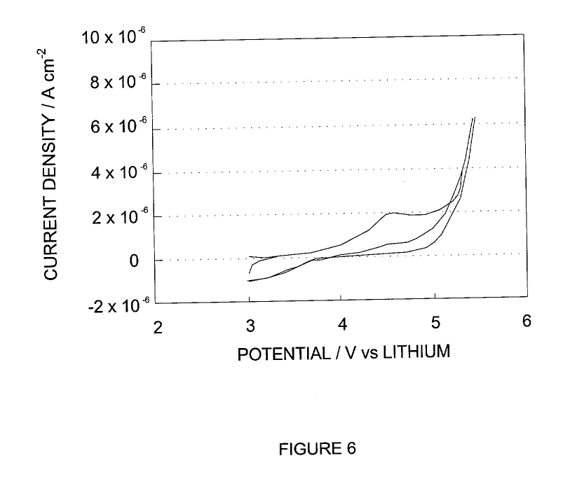

FIG. 6 is a trace of current density vs. potential during repeated voltage sweep of a cell made according to this invention at a scan rate of 5 mV/sec. It shows the electrochemical stability with 60 wt % branched type siloxane polymer (n=7.2, R′ and R″ are methyl groups in formula I-a infra), 30 wt % poly(ethylene glycol) ethyl ether methacrylate, 10 wt % of poly(ethylene glycol-600) dimethacrylate and Li(CF₃SO₂)₂N. More specifically, it shows the electrochemical stability of IPN SPE with the same composition as Example 1. Polypropylene melt-blown type nonwoven separator material is used as a supporter for this IPN SPE. The electrochemical stability window of this IPN polymer electrolyte was determined by cyclic voltammetry with a 2030 button cell assembled by sandwiching this IPN SPE between a stainless steel disc as a working electrode and lithium metal disc as the counter and reference electrodes. This IPN SPE shows an excellent electrochemical stability window of over 4.5V. and only a minimal decomposition peak around 4.5V. during the first anodic sweep. Notably, except for a slight variation during the first cycle, each subsequent cycle shows almost identical current density versus potential. This level of electrochemical stability during repeated cycling is extraordinary.

### COMPARISONS 1 AND 2, AND EXAMPLE 4

Accelerating rate calorimetry (ARC) was used to investigate the chemical and thermal degradation of branched type siloxane polymer and its IPN polymer electrolyte at elevated temperatures of up to 400° C.. The ARC is an adiabatic calorimeter in which heat evolved from the test sample is used to raise the sample temperature. The ARC is conducted by placing a sample in a sample bomb inside an insulating jacket. In an ARC analysis, the sample is heated to a preselected initial temperature and held a period of time to achieve thermal equilibrium. A search is then conducted to measure the rate of heat gain (self-heating) of the sample. If the rate of self-heating is less than a preset rate after the programmed time interval (typically 0.02° C. min⁻¹), the sample temperature is stepped to a new value, and the heat-wait-search sequence is repeated. Once a self-heating rate greater than the present value is measured, the heat-wait-search sequence is abandoned; the only heating supplied to the calorimeter thereafter is that required to maintain the adiabatic condition between the sample and the jacket. Heat generated from the reaction inside the sample increases its temperature and pressure, thereby increasing the rate of the reaction. Sample weight for the test was 500 mg. Each sample was introduced in a 2¼″×¼″ diameter stainless steel bomb as a sample for ARC test. The detail compositions are explained in Table 2.

TABLE 2
[grams]

| | Branched siloxane | | |
|---|---|---|---|
| Sample | polymer | PEGDMA600 | LiTFSI |
| Comparison 1 | 0.5000 | — | — |
| Comparison 2 | 2.0000 | — | 0.3205 |
| Example 4 | 2.0000 | 1.3333 | 0.3495 |

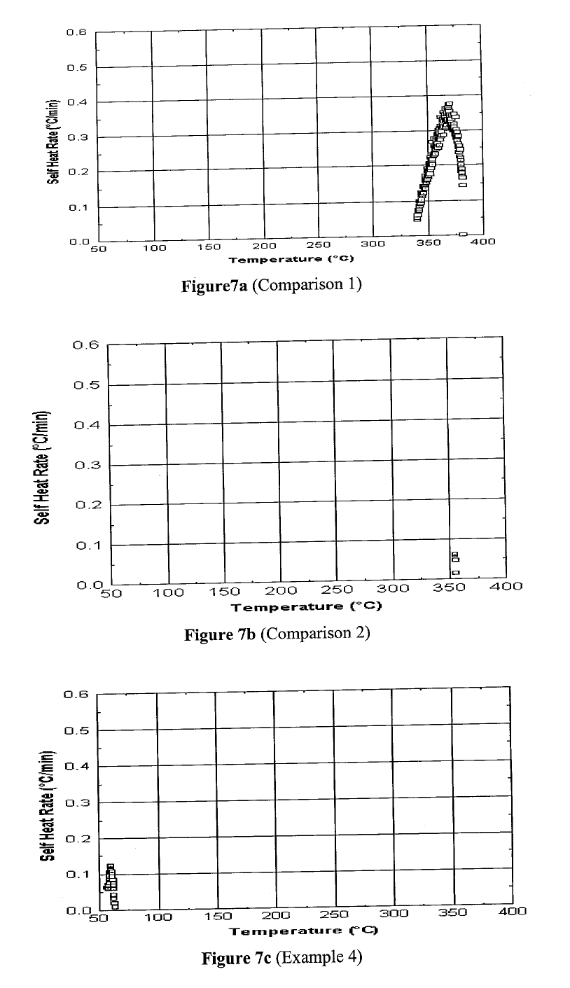

FIGS. 7a-c show the heat flow from decomposition reaction of the samples. FIG. 7a(Comparison 1) shows its rapid reaction due to thermal decomposition and carbonization around 350° C. (662° F.). FIG. 7b (Comparison 2) shows better thermal behavior caused by the coordination bonds between oxygen atoms and the lithium salt, which has a thermal stability of over 350° C. (662° F.), but there was still decomposition reaction around 360-370° C. (648° F.-698° F.). FIG. 7c (Example 4) shows only the heat of reaction due to thermal crosslinking to make an IPN structure at 60° C. (140° F.) and then no significant decomposition reaction was detected up to 400° C. (752° F.). It was thus found that the IPN structure significantly enhances the thermal stability of its SPE.

### EXAMPLE 7

### Lithium Ion Transference Number

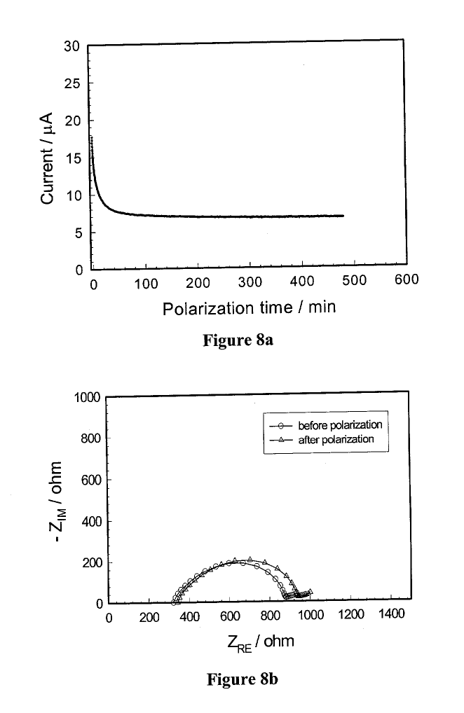

Li metal/IPN SPE of Example 2/Li metal cell was assembled for the measurement of Li ion transference number t₊. A 2030 button cell was used. A potentiostatic curve (FIG. 8a) was measured by using dc polarization method and the change of the cell impedance before and after polarization (FIG. 8b) was examined by using Schlumberger model 1255 frequency response analyzer connected to Schlumberger model 1286 electrochemical interface and EG&G PAR 273 potentiostat. The Li transference number was given by following equation suggested by K.M. Abraham et al., Chem. Mater., 9, 1978 (1997):

$${t}_{+} = \frac{{I}_{s} {R}_{b}^{s} ( V - {I}_{o} {R}_{i}^{o} )}{{I}_{o} {R}_{b}^{o} ( V - {I}_{s} {R}_{i}^{s} )}$$

Wherein V is the dc potential applied across the symmetric cell, o and s represent the initial and steady state, and b and i represent bulk and interfacial resistance of the electrolyte.

Lithium transference number of IPN SPE of Example 2 was approximately 0.29, which is much improved over that of pure PEO SPE, which is about 0.015.

### EXAMPLE 8

### Cell Test

IPN SPE was prepared using the same composition as in Example 1 with a nonwoven support material. A 2030 button cell was assembled with lithium metal as an anode, IPN SPE of Example 8 and LiNi_{0.8}Co_{0.2} O₂ as a cathode. The preparation method for assembling the 2030 button cell with the SPE of Example 8, comprised the steps of: coating the precursor solution of Example 8 onto cathode laminate; stacking IPN SPE and lithium metal; putting a plate spring and top lid on the stacked components to 2030 button cell and crimping; curing the cell to change the precursor solution to SPE at 70° C. for 1 hr.

The composition of the cathode is listed in Table 3. The effective cell area was 1.6 cm². Charge and discharge rate were C/6. There was no degradation peak caused by the metal oxide up to 4.1V. and the specific discharge capacity was over 130 mAh/g.

TABLE 3

| | Composition [wt %] | | | |
|---|---|---|---|---|
| Electrode | LiNi_{0.8}Co_{0.2}O₂ | PVdF* | Graphite | Carbon black |
| Cathode | 84 | 8 | 4 | 4 |

*poly(vinylidene fluoride)

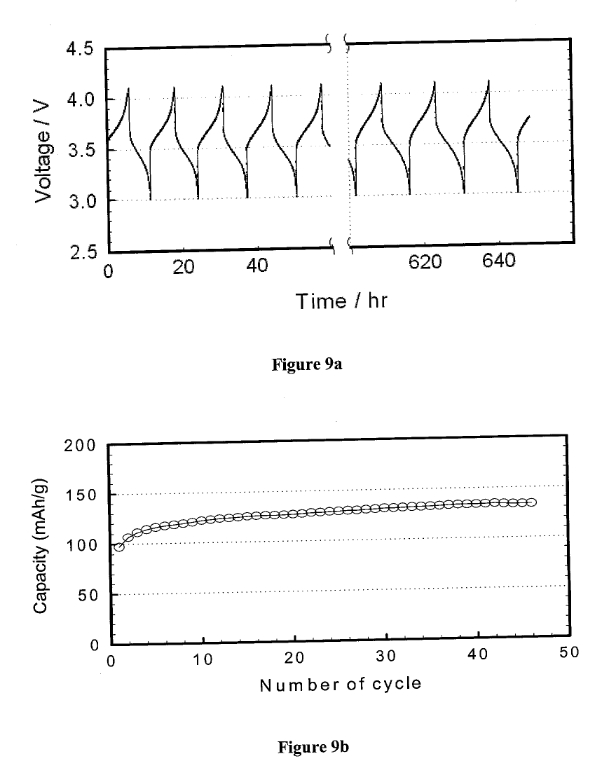

The remarkable electrochemical stability of the present invention is illustrated by FIGS. 9a and 9b. It can be seen in FIG. 9a that after 48 cycles (charges and discharges) there was no decrease in capacity at all. Although the cathode material, LiNi_{0.8}Co_{0.2} O₂, is a strong oxidizing material, the IPN SPE of this invention does not show any degradation problem up to 4.1V. FIG. 9b shows that the capacity of the test cell made according to the present invention increased in capacity from 100 mAh/g to about 130 mAh/g over the first approximately 40 cycles, then remained stable at that level.

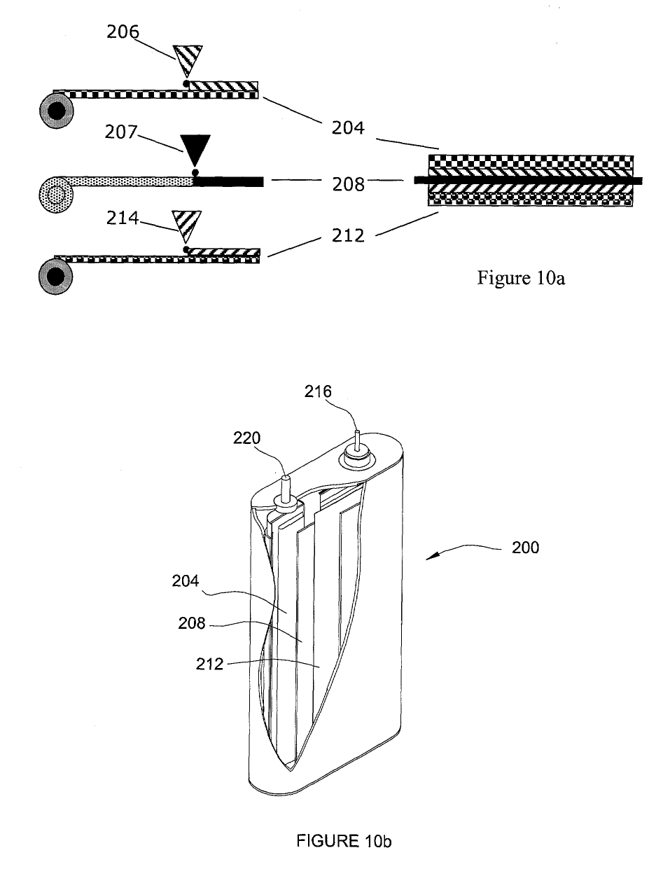

FIGS. 10a and 10b illustrate the construction of an electrochemical cell 200 incorporating the SPE of the best mode of the present invention. This prismatic “wound” type cell (“jelly roll”) comprises (1) a cast positive electrode material 204 made of metal oxide active material, PVDF binder and carbon additive with the precursor solution made of the mixture of comb siloxane polymer, poly(ethylene glycol) ethyl ether methacrylate, poly(ethylene glycol) dimethacrylate and lithium salt Li(CF3SO2)2N 206, (2) porous polycarbonate film 208 cast with the precursor solution of comb siloxane polymer, poly(ethylene glycol) ethyl ether methacrylate, poly(ethylene glycol) dimethacrylate and lithium salt Li(CF3SO2)2N 207, and (3) a cast porous negative electrode 212 made of carbon and PVDF binder with the precursor solution made of the mixture of comb siloxane polymer, poly(ethylene glycol) ethyl ether methacrylate, poly(ethylene glycol) dimethacrylate and lithium salt Li(CF3SO2)2N 214. The positive and negative electrodes 204 and 212 are electrically coupled to terminals 216 and 220.

This invention is equally applicable to related technologies including super capacitors and hybrid devices incorporating aspects of capacitors and batteries. For the purposes of this patent, “electrochemical cell” shall refer to all forms of electrochemical storage devices, including single cells, batteries, capacitors, super capacitors and hybrid electrochemical devices.

### BEST MODE OF THE PRESENT INVENTION

The inventors believe the best mode for the IPN polymer electrolyte is with the composition of 10 wt % to 80 wt %, more preferably about 30 wt % to 75 wt %, even more preferably about 50 wt % to 70 wt %, comb type siloxane polymer (n=7.2 in formula I-a), 30wt % poly(ethylene glycol) ethyl ether methacrylate, 10 wt % of poly(ethylene glycol) dimethacrylate with molecular weight of 600 and Li(CF₃SO₂)₂N supported by porous polycarbonate membrane. This composition and construction shows the highest ionic conductivity of 3.6×10⁻⁵ S/cm at 25° C. and 5.1×10⁻⁵ S/cm at 37° C.. The crosslinking agent should constitute between 5% to 60%, more preferably between 10% and 40%, by weight of all organic compounds in the SPE. The monomeric compound for controlling crosslinking density should constitute about 15% to 40% by weight of the total weight of organic compounds in the SPE. The thickness of porous polycarbonate membrane should be approximately 20 μm and the total thickness of the IPN polymer electrolyte should be about 95 μm. The radical reaction initiator should be a thermal initiator such as benzoyl peroxide and azoisobutyronitrile.

The inventors further believe the best method of assembly is as follows:

Step 1. Cast the porous polycarbonate film with a liquid solution made of the mixture of comb siloxane polymer, poly(ethylene glycol) ethyl ether methacrylate, poly(ethylene glycol) dimethacrylate and lithium salt Li(CF₃SO₂)₂N.

Step 2. Cast the porous positive electrode made of oxide active material, PVDF binder and carbon additive with the liquid solution made of the mixture of comb siloxane polymer, poly(ethylene glycol) ethyl ether methacrylate, poly(ethylene glycol) dimethacrylate and lithium salt Li(CF₃SO₂)₂N.

Step 3. Cast the porous negative electrode made of carbon and PVDF binder with the liquid solution made of the mixture of comb siloxane polymer, poly(ethylene glycol) ethyl ether methacrylate, poly(ethylene glycol) dimethacrylate and lithium salt Li(CF₃SO₂)₂N.

Step 4. Wind the cast porous polycarbon film with the cast positive and negative electrode in prismatic wound configuration.

Step 5. Put the jelly roll in a flexible packaging and seal.

Step 6. Cure the cell at 80° C. for 1 h.

Step 7. Seal the cell packaging.

Having described the present invention, it should be apparent to the reader that many variations of the present invention are possible without departure from the scope of the present invention. The specific implementations disclosed above are by way of example and for the purposes of enabling persons skilled in the art to implement the invention only. Accordingly, the invention is not to be limited except by the appended claims and legal equivalents.

1. In an electrochemical cell, an interpenetrating network solid polymer electrolyte comprising at least one branched siloxane polymer having one or more poly(alkylene oxide) branch as a side chain, at least one crosslinking agent, at least one monofunctional monomeric compound for controlling crosslinking density, at least one metal salt and at least one radical reaction initiator.

2. The interpenetrating network solid polymer electrolyte of claim 1, wherein said poly(alkylene oxide) side chain of siloxane polymer is represented by formulas (I-a and I-b) as a metal ion conducting phase, 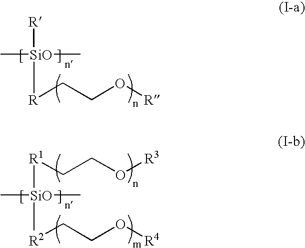
where each of R, R¹ and R² represents oxygen or a group selected from an alkylene oxide group having 1 to 6 carbon atoms; each of R′, R″, R³ and R⁴ represents hydrogen or a group selected from an alkyl group having 1 to 12 carbon atoms and/or an alkenyl group having 2 to 8 carbon atoms; each of n and m represents whole numbers from 1 to 12; and
n′ represents whole numbers from 10-10,000.

3. The interpenetrating network solid polymer electrolyte of claim 1, wherein said crosslinking agent is represented by formula (II), 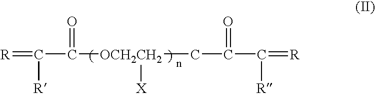
where R represents a group selected from an alkyl group having 1 to 10 carbon atoms; and each of R′ and R″ represents hydrogen or a group selected from an alkyl group having 1 to 10 carbon atoms and/or an alkenyl group having 2 to 12 carbon atoms; X is hydrogen or methyl group; and n represents a whole number from of 1 to 15.

4. The interpenetrating network solid polymer electrolyte of claim 1, wherein said monomeric unit for controlling crosslinking density is represented by formula (III), 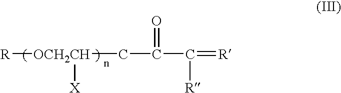
where each of R and R′ represents a group selected from an alkyl group having 1 to 10 carbon atoms; and R″ represents hydrogen or a group selected from an alkyl group having 1 to 10 carbon atoms and/or an alkenyl group having 2 to 12 carbon atoms; X is hydrogen or a methyl group; and n represents a whole number from 1 to 20.

5. The interpenetrating network solid polymer electrolyte of claim 2, wherein the branched siloxane polymer contained therein in a proportion of 10 to 80 percent by weight of total weight of organic compounds in the solid polymer electrolyte.

6. The interpenetrating network solid polymer electrolyte of claim 2, wherein said proportion of said branched siloxane polymer is 30 to 75 percent by weight of total weight of organic compounds in the solid polymer electrolyte.

7. The interpenetrating network solid polymer electrolyte of claim 2, wherein said proportion of said the branched siloxane polymer is 50 to 70 percent by weight of total weight of organic compounds in the solid polymer electrolyte.

8. The interpenetrating network solid polymer electrolyte of claim 3, wherein said crosslinking agent is contained in a proportion of 5 to 60 percent by weight of total weight of organic compounds in the solid polymer electrolyte.

9. The interpenetrating network solid polymer electrolyte of claim 3, wherein said crosslinking agent is contained in a proportion of 10 to 40 percent by weight of total weight of organic compounds in the solid polymer electrolyte.

10. The interpenetrating network solid polymer electrolyte of claim 4, wherein said monomeric compound exists in a proportion of 10 to 50 percent by weight of total weight of organic compounds in the solid polymer electrolyte.

11. The interpenetrating network solid polymer electrolyte of claim 4, wherein said monomeric compound exists in a proportion of 15 to 40 percent by weight of total weight of organic compounds in the solid polymer electrolyte.

12. The interpenetrating network solid polymer electrolyte of claim 1, wherein said at least one metal salt is a lithium salt.

13. An interpenetrating network polymer electrolyte of claim 12, wherein said lithium salt comprises one or more of the following: LiClO₄, LiBF₄, LiAsF₆, LiPF₆, LiCF₃SO₃, Li(CF₃SO₂)₂N, Li(CF₃SO₂)₃C, LiN(SO₂C₂F₅) ₂, lithium alkyl fluorophosphates and a mixture thereof.

14. The interpenetrating network solid polymer electrolyte of claim 12, wherein molar ratio of said lithium salt relative to the total molar concentration of oxygen in all of the organic compounds in the polymer electrolyte is 0.01 to 0.2.

15. The interpenetrating network solid polymer electrolyte of claim 1, wherein said at least one radical reaction initiator is a thermal initiator.

16. The interpenetrating network polymer electrolyte of claim 15, wherein the thermal initiator is selected from azo compounds, peroxide compounds, bismaleimide and mixtures thereof.

17. The interpenetrating network polymer electrolyte of claim 16, wherein said azo compounds include azoisobutyronitrile.

18. The interpenetrating network polymer electrolyte of claim 16, wherein said peroxide compounds include benzoylperoxide.

19. The interpenetrating network polymer electrolyte of claim 1, wherein said electrolyte is incorporated into a porous medium.

20. The interpenetrating network polymer electrolyte of claim 19, wherein said porous medium is selected from polyolefin separator, polyolefin nonwoven type separator and polycarbonate microporous membrane.

21. A method for preparing the interpenetrating network polymer electrolyte of claim 1, comprising the steps of:
a) dissolving a lithium salt and a radical initiator in a branched siloxane polymer; mixing at least one crosslinking agent and a monomeric compound with the resulting solution;
b) casting the resulting mixture onto a substrate; and placing the cast liquid film in an oven or a heating medium such as hot plate for solidification thereof.

22. The method of claim 21 wherein said substrate is a porous medium.

23. The method of claim 21 wherein said substrate is a surface of an electrode.

24. A lithium ion rechargeable cell comprising of at least one lithium metal or lithium alloy anode, the solid polymer electrolyte of claim 1, and at least one metal oxide cathode.

25. A lithium rechargeable cell comprising at least one carbon anode, interpenetrating network solid polymer electrolyte of claim 1, and at least one metal oxide cathode.

26. A method for assembling a lithium rechargeable cell with the solid polymer electrolyte, comprising the steps of:
a) coating at least one branched siloxane polymer having one or more poly(alkylene oxide) as a side chain, at least one crosslinking agent, at least one monofunctional monomeric compound for controlling crosslinking density, at least one metal salt and at least one radical reaction initiator onto one or more surfaces of a porous supporter, a cathode laminate and anode laminate;
b) curing the precursor solution to make solid polymer electrolyte;
c) stacking each components including porous supporter, cathode laminate and anode laminate;
d) winding or folding the stacked components to prepare spiral wound cell or prismatic cell; and
e) packaging the cell in a metal can, plastic pouch or foil-plastic laminated pouch.

27. A method for assembling a lithium ion rechargeable cell with the solid polymer electrolyte, comprising the steps of:
a) coating at least one branched siloxane polymer having one or more poly(alkylene oxide) as a side chain, at least one crosslinking agent, at least one monofunctional monomeric compound for controlling crosslinking density, at least one metal salt and at least one radical reaction initiator onto one or more surfaces of a porous supporter, a cathode laminate and an anode laminate;
b) stacking each component including said porous supporter, said cathode laminate and said anode laminate;
c) winding or folding the stacked components to prepare spiral wound cell or prismatic cell;
d) curing the cell to change the precursor solution to solid polymer electrolyte; and packaging the cell with metal can, plastic pouch, or foil-plastic laminated pouch..

28. A method for assembling a lithium rechargeable cell with the solid polymer electrolyte of claim 8, comprising the steps of:
a) stacking each component including a porous supporter, at least one cathode laminate and at least one anode laminate to assemble the cell;
b) winding or folding the stacked components to prepare a spiral wound cell or prismatic cell; putting the cell in a metal can, plastic pouch or foil-plastic laminated pouch; injecting the mixture of the electrolyte components listed in claim 1 into the pre-assembled cell; and
c) curing the cell to change the precursor solution to solid polymer electrolyte.
